(19) United States
(12) Patent Application Publication
(10) Pub. No.: US 2022/0196116 A1
(43) Pub. Date: Jun. 23, 2022

(54) CYCLOIDAL REDUCER

(71) Applicant: OMME GEARS S.A.S., Falconara Marittima (IT)

(72) Inventor: Massimo MANCINI, Falconara Marittima (IT)

(21) Appl. No.: 17/599,910

(22) PCT Filed: Mar. 31, 2020
(86) PCT No.: PCT/IT2020/050082

§ 371 Date: Sep. 29, 2021

(30) Foreign Application Priority Data
Apr. 1, 2019 (IT) 102019000004871

(51) Int. Cl. F16H 1/32

(52) U.S. Cl. CPC F16H 1/32; F16H 2001/325

(57) ABSTRACT

The cycloidal reducer comprises an input shaft (2) suitable for being operated according to a rotation motion around a rotation axis (A) at an input angular speed, and an output shaft (3), capable of receiving a rotation motion around the same rotation axis (A), at an output angular speed, reduced according to a predetermined reduction ratio with respect to the input angular speed.

### TECHNICAL FIELD

The present invention relates to a cycloidal reducer.

### PRIOR ART

Apparatuses called reducers, capable of transmitting a rotary motion from an input shaft to an output shaft with a reduction in the number of turns and possibly an increase in the transmitted torque, have been known for some time. These devices are used in various technical sectors, in general for the coupling of driving machines and operating machines, when direct coupling is not appropriate or not possible to carry out.

Different types of reducers are known, which differ in the nature of the members used to carry out the said reduction. Among them, the cycloidal reducers generally consist of an input shaft, which, through an eccentric member, transmits a rotational motion to an output shaft, at a reduced angular speed of a certain reduction ratio.

More precisely, the eccentric member causes the rotation of a pair of cams having a cycloidal profile. Thanks to the rolling of this cycloidal profile on fixed pins brought by the reducer's containment box, the pair of cams transmits the rotational motion of the input shaft, reversing it, by means of drive pins and drive rollers which in turn roll inside the special openings made in the cams themselves.

These types of reducers therefore comprise many mechanical parts, including high performance bearings, for a correct transmission of the rotational motion of the input shaft. In addition, all the mechanical components involved must be made with high precision, therefore ensuring very close geometrical and shape tolerances, using specific materials, processes and mechanical treatments, such as grinding processes.

All of this, as is quite understandable, considerably raises the costs of known cycloidal reducers.

For example, patent EP 0305535 describes an epicycloidal reducer internally comprising an epicycloidal reduction unit and a planetary epicycloidal unit.

RO 116121 illustrates a planetary reducer comprising cylindrical planetary gears radially arranged and equally spaced on the circumference of a cam having a cylindrical shape, eccentric to a driving shaft. The planetary gears engage an internal gear such that rotation of the cam produces rotation of the planetary gears in the opposite direction, at a reduced speed with respect to the motor shaft.

EP 0474897 describes a planetary cycloidal device for changing the speed from an input shaft to an output shaft.

Furthermore, given the number of the components and the consequent structural complexity, the gearboxes of the known type do not fully meet the needs of the industrial sectors affected by their application, as they are often bulky, in relation to the specific needs of use.

### DISCLOSURE

An object of the present invention is to solve the mentioned problems, by devising a cycloidal reducer, which obtains an optimal functioning, in particular by providing high performances with a compact construction.

Another object of the present invention is to provide a cycloidal reducer of simple construction and functional conception, provided with safe and reliable use, as well as relatively inexpensive cost.

The mentioned objects are achieved, according to the present invention, by the cycloidal reducer according to claim 1.

The cycloidal reducer according to the invention comprises an input shaft suitable for being operated according to a rotational motion around a rotation axis at an input angular speed, an output shaft, suitable for rotating around the same rotation axis, a containment box containing a plurality of housing seats for a plurality of fixed pins, a first cam and a second cam peripherally having a respective cycloidal profile suitable for engaging said fixed pins by rolling. The first cam and said second cam are assembled rotatably on the input shaft and each have a plurality of guide openings distributed around a respective center. The output shaft has a plurality of drive seats distributed around the rotation axis. The reducer also comprises a plurality of drive pins inserted through the aforementioned guide openings and drive seats, to transform the rotational motion of the input shaft into a further rotational motion of the output shaft, at an angular speed reduced according to a predetermined reduction ratio with respect to the input angular velocity.

According to a prerogative of the invention, the input shaft shapes an eccentric portion made integrally to the input shaft, around the rotation axis, on which the first cam and the second cam are rotatably coupled.

More precisely, this provision allows the optimization of the mechanical processes necessary for the construction of the reducer, which is also very compact.

In particular, the provision of the eccentric portion, made integrally with the input shaft, enables an optimal operation of the reducer according to the invention, in particular by providing high performance with a compact construction.

Preferably, said eccentric portion is made integrally with the input shaft, in the form of a first eccentric ring and a second eccentric ring around the rotation axis.

According to the invention, the first cam and the second cam are rotatably coupled directly on the eccentric portion of the input shaft, considerably simplifying the structure of the reducer.

The direct coupling between the eccentric portion and the input shaft eliminates the need of rotating support components, in particular expensive and bulky rolling bearings. Consequently, the reducer according to the invention has a simplified structure, of relatively small size, therefore suitable for numerous specific applications, which require high reduction ratios in very small spaces.

For example, thanks to the structural simplification thus achieved, it is possible to use the cycloidal reducer according to the invention also in those technical sectors, such as that of articular prostheses, in which, in fact, high transmission ratios are required in very small spaces.

Moreover the reducer according to the invention enables the use of mechanical parts, in particular the first cam and the second cam, which may be produced without special apparatuses, simply optimizing the software programs of realization.

In addition, each mechanical piece can be made of materials that are easy to find, for example ordinary steel, without particular heat treatments.

Therefore the cycloidal reducer according to the invention is particularly compact and economical for the same performance. In particular, it allows high reduction ratios to be obtained in considerably narrowed spaces.

In particular, the first cam is preferably coupled rotatably directly on the first eccentric ring and the second cam is preferably coupled rotatably directly on the second eccentric ring of the eccentric portion of the input shaft.

Preferably the eccentric portion comprises an anti-friction material coating arranged at an area of coupling with the first cam and the second cam. Said coating reduces the friction actions in the operation of the reducer, optimizing its performance.

Preferably, said coating is based on molybdenum.

Said drive pins are preferably coupled to the first cam and to the second cam respectively, through the interposition of revolving support means, made by means of respective bushings, inserted in respective through seats of the first cam and of the second cam.

Preferably said bushings are inserted in said guide openings of said first cam and said second cam.

Preferably, a shim ring is axially inserted between the first cam and the second cam.

Preferably the first eccentric ring and the second eccentric ring are angularly staggered with respect to the rotation axis.

### DESCRIPTION OF DRAWINGS

The details of the invention will become clearer from the detailed description of a preferred embodiment of the cycloidal reducer, illustrated only by way of non-limitative example in the accompanying drawings, where:

FIG. 1 shows a sectional side view of the cycloidal reducer according to the invention;

FIGS. 2 and 3 show respectively a perspective view of the cycloidal reducer according to the invention, from the opposite sides.

### BEST MODE

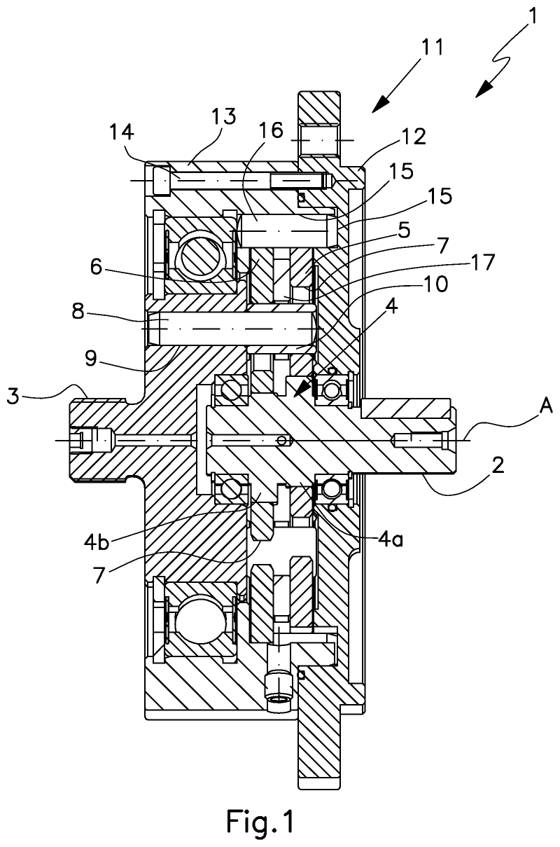

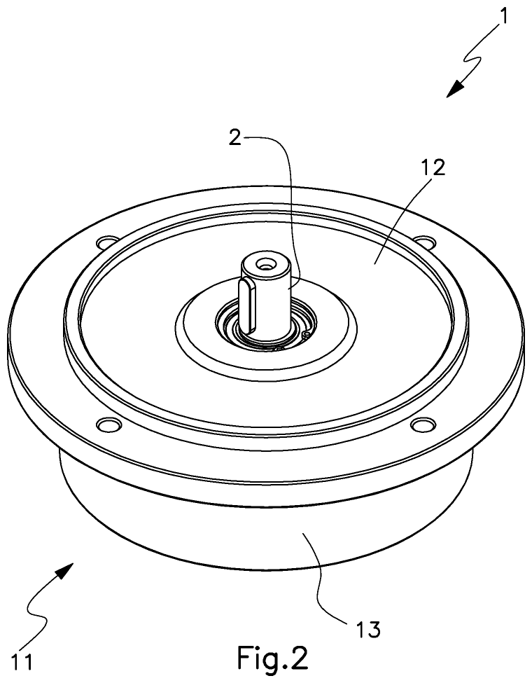

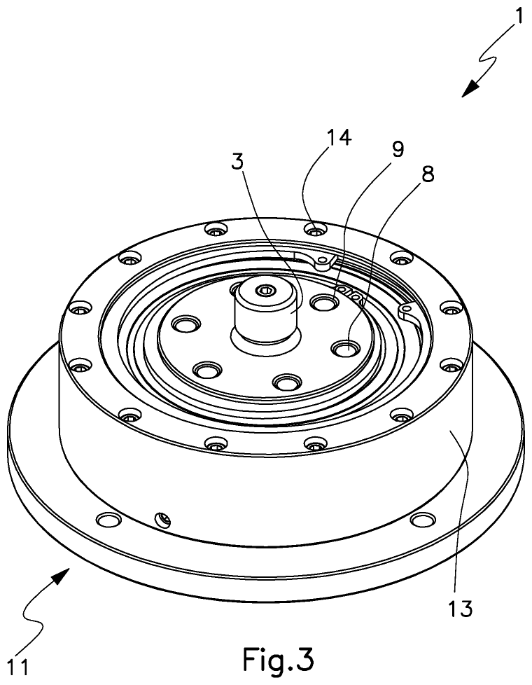

With particular reference to FIGS. 1 and 3, a cycloidal reducer according to the invention has been indicated as a whole with the reference number 1.

The cycloidal reducer 1 comprises an input shaft 2, suitable for being operated according to a rotation motion about a rotation axis A at an input angular speed and an output shaft 3, suitable for rotating around the same rotation axis A, according to a further rotation motion at a reduced angular speed according to a predetermined reduction ratio with respect to the input angular speed.

In particular, the further rotation motion dragged from the input shaft 2 to the output shaft 3 is, in addition to being reduced, transformed in the opposite direction with respect to the aforementioned input rotation motion.

The input shaft 2 forms an eccentric portion 4, in particular made integrally with the shaft 2 itself, in the form of a first eccentric ring 4a, and a second eccentric ring 4b, around the rotation axis A.

The reducer 1 also shapes a first cam 5 and a second cam 6, configured to be rotatably coupled to the aforementioned eccentric portion 4, respectively with the first eccentric ring 4a and with the second eccentric ring 4b, and having peripherally a respective cycloidal profile, for driving the output shaft 3 into said further rotational motion as described in detail below.

In particular, the coupling between the first cam 5 and the second cam 6 and the eccentric portion 4 is of the direct type, therefore without the interposition, in particular, of appropriate rolling bearings.

The first cam 5 and the second cam 6 also comprise, respectively, a plurality of guide openings 7, which cooperate to house respective drive pins 8.

In turn, the output shaft 3 comprises a plurality of drive seats 9, configured to house a corresponding portion of the aforementioned drive pins 8, thus allowing the transmission of rotational motion from the input shaft 2 to the output shaft 3.

Said drive pins 8 are coupled to the first cam 5 and to the second cam 6 respectively, by means of the interposition of revolving support means 10, for example made by means of respective bushings, inserted in respective through seats of the first cam 5 and of the second cam 6.

As anticipated, the first cam 5 and the second cam 6 are advantageously coupled directly on the eccentric portion 4 of the input shaft 2, without the interposition of rolling means.

Therefore, preferably, the input shaft 2 provides, at the areas of coupling with the first cam 5 and with the second cam 6, a coating of anti-friction material, for example based on molybdenum.

In particular, the eccentric portion 4 comprising the first eccentric ring 4a and the second eccentric ring 4b is integrally made at the input shaft 2, thus enabling its structural complexity to be reduced and avoiding the use of rolling support means, for example high performance bearings, for the specific coupling.

The cycloidal reducer 1 also comprises a containment box 11, preferably divided into an input cover 12 and an output cover 13, to contain the functional components of the reducer itself, in particular to support the input shaft 2 and the output shaft 3 through the interposition of rolling support means of a known type.

In particular, the input cover 12 and the output cover 13 may be fixed to each other by means of fixing elements 14 of known type, for example made by means of screws.

Said containment box 11 internally bears a plurality of housing seats 15 for a plurality of fixed pins 16. Preferably, said housing seats 15 are made jointly by the input cover 12 and the output cover 13 (see FIG. 1).

A shim ring 17 may be inserted axially between the first cam 5 and the second cam 6.

The operation of the cycloidal reducer according to the invention is easily understood from the above description.

When the input shaft 2 is operated according to the rotation motion about the rotation axis A, said motion rotates the eccentric portion 4 carried by the same input shaft 2, on which the first cam 5 and the second cam 6 roll.

The first cam 5 and the second cam 6, which roll with a certain phase displacement, also cause the rolling of the respective cycloidal profiles on the fixed pins 16 and at the same time, the rotation, in particular in the opposite direction, of the drive pins 8 carried by the same first cam 5 and second cam 6.

Following said drive, the output shaft 3 which carries the drive pins 8 in the respective drive seats 9 is driven by said further rotation motion, according to a reduced angular speed according to a certain reduction ratio.

The cycloidal reducer according to the invention therefore achieves the aim of enabling optimal operation, in particular by providing high performance with a compact construction.

The cycloidal reducer described by way of example may be modified according to the different needs.

In the practical embodiment of the invention, the materials used, as well as the shape and the dimensions, may be modified depending on requirements.

Should the technical features mentioned in any claim be followed by reference signs, such reference signs were included strictly with the aim of enhancing the understanding of the claims and hence they shall not be deemed restrictive in any manner whatsoever on the scope of each element identified for exemplifying purposes by such reference signs.

1. A cycloidal reducer comprising
an input shaft configured to be driven according to a rotation motion around a rotation axis at an input angular speed,
an output shaft configured to rotate around said rotation axis,
a plurality of fixed pins,
a containment box carrying a plurality of housing seats for the plurality of fixed pins,
a first cam and a second cam having peripherally a respective cycloidal profile capable of engaging by rolling said fixed pins, said first cam and said second cam being assembled rotatably on said input shaft and each one having a plurality of guide openings distributed around a respective center, said output shaft comprising a plurality of drive seats distributed around said rotation axis, p1 a plurality of drive pins inserted through said guide openings and said drive seats, to transform said rotational motion of said input shaft into a further rotational motion of said output shaft, at a reduced angular speed according to a predetermined reduction ratio with respect to said input angular speed, and
an eccentric portion made integrally to said input shaft around said rotation axis, said first cam and said second cam being rotatably and directly coupled on said eccentric portion of said input shaft.

2. A cycloidal reducer as in claim 1, wherein said eccentric portion is made in the form of a first eccentric ring and a second eccentric ring around said rotation axis.

3. A cycloidal reducer as in claim 2, wherein said first cam is coupled rotatably directly on said first eccentric ring and said second cam is coupled rotatably directly on said second eccentric ring of said eccentric portion of said input shaft.

4. A cycloidal reducer as in claim 3, wherein said eccentric portion comprises a coating of anti-friction material arranged at a coupling area with said first cam and said second cam.

5. A cycloidal reducer as in claim 4, wherein said coating of antifriction material is based on molybdenum.

6. A cycloidal reducer as in claim 1, wherein said drive pins are coupled to said first cam and to said second cam respectively, through the interposition of revolving support means, made by means of respective bushings, inserted in said guide openings of said first cam and of said second cam.

7. A cycloidal reducer as in claim 1, wherein between said first cam and the said second cam, a shim ring is inserted axially.

8. A cycloidal reducer as in claim 2, wherein said first eccentric ring and said second eccentric ring are made angularly staggered from each other with respect to said rotation axis.

9. A cycloidal reducer as in claim 2, wherein said drive pins are coupled to said first cam and to said second cam respectively, through the interposition of revolving support means, made by means of respective bushings, inserted in said guide openings of said first cam and of said second cam.

10. A cycloidal reducer as in claim 6, wherein said first eccentric ring and said second eccentric ring are made angularly staggered from each other with respect to said rotation axis.
